(19) United States
(12) Patent Application Publication
(10) Pub. No.: US 2026/0343492 A1
(43) Pub. Date: Oct. 29, 2026

(54) METHOD AND DEVICE FOR BEAM MANAGEMENT BASED ON RESOURCE SENSING IN SIDELINK COMMUNICATION

(71) Applicants: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(72) Inventors: Ui Hyun HONG, Hwaseong-si, Gyeonggi-do (KR); Hyuk Min SON, Seoul (KR)

(73) Assignees: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(21) Appl. No.: 19/114,302

(22) PCT Filed: Oct. 24, 2023
(86) PCT No.: PCT/KR2023/016566

§ 371 Date: Mar. 21, 2025

(30) Foreign Application Priority Data
Oct. 28, 2022 (KR) 10-2022-0141705

(51) Int. Cl. H04W 72/02; H04W 72/25; H04W 72/566

(52) U.S. Cl. CPC H04W 72/02; H04W 72/25; H04W 72/566

(57) ABSTRACT

Disclosed are a method and device for beam management based on resource sensing in sidelink communication. A method of a first UE comprises the steps of: determining a resource by performing an RSS operation; comparing priorities between a first signal to be transmitted by the first UE in the resource and a second signal to be transmitted by a second UE in the resource; determining whether to perform a preemption operation for the resource on the basis of a comparison result of the priorities; and performing SL communication depending on whether the preemption operation is performed.

### TECHNICAL FIELD

The present disclosure relates to a sidelink communication technique, and more particularly, to a technique for beam management based on resource sensing.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHZ. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability.

The 6G communication network can support diverse and wide frequency bands and can be applied to various usage scenarios such as terrestrial communication, non-terrestrial communication, sidelink communication, and the like.

Meanwhile, sidelink communication between terminals may be performed based on a beamforming scheme, and a beam management operation for sidelink communication may be required. The first terminal may transmit a beam management signal for beam management operation. When the transmission of the beam management signal of the first terminal and transmission of sidelink (SL) data of a second terminal are required in the same resource, methods to resolve the collision issue between the transmissions are needed.

### DISCLOSURE

### Technical Problem

The present disclosure is directed to providing a method and an apparatus for beam management based on resource sensing in sidelink communication.

### Technical Solution

A method of a first user equipment (UE), according to exemplary embodiments of the present disclosure for achieving the above-described objective, may comprise: determining a resource by performing a resource sensing and selection (RSS) operation; comparing priorities between a first signal that the first UE intends to transmit in the resource and a second signal that the second UE intends to transmit in the resource; determining whether to perform a pre-emption operation for the resource based on a result of comparing the priorities; and performing sidelink (SL) communication based on whether to perform the pre-emption operation.

The method may further comprise: receiving an enable/disable indicator for the pre-emption operation from a base station, wherein when the enable/disable indicator indicates enabling of the pre-emption operation, the first UE may determine whether to perform the pre-emption operation for the resource.

The method may further comprise: receiving, from a base station, configuration information indicating enabling/disabling of the pre-emption operation between SL data transmissions, enabling/disabling of the pre-emption operation between beam management (BM) signal transmissions for BM operation, and enabling/disabling of the pre-emption operation between SL data transmission and BM signal transmission, wherein whether to perform the pre-emption operation for the resource may be determined based on the configuration information.

Enabling or disabling of the pre-emption operation may be configured per resource pool (RP).

A first priority of the first signal may be included in first sidelink control information (SCI) transmitted by the first UE, and a second priority of the second signal may be included in second SCI transmitted by the second UE.

Each of the first signal and the second signal may be a BM signal or SL data, and SCI for transmission of the BM signal may be distinct from SCI for transmission of the SL data.

The SL data may be transmitted in an SL-RP, the BM signal may be transmitted in a BM-RP configured for BM operation or the SL-RP, and the BM-RP may be configured to be distinguished from the SL-RP.

When a priority of a BM signal is higher than a priority of SL data, the first signal is the BM signal, and the second signal is the SL data, the pre-emption operation for the resource may not be performed, and the BM signal may be transmitted in the resource.

When a priority of a BM signal is higher than a priority of SL data, the first signal is the SL data, and the second signal is the BM signal, the pre-emption operation for the resource may be performed, and the SL data may not be transmitted in the resource.

When a priority of a BM signal is lower than a priority of SL data, the first signal is the BM signal, and the second signal is the SL data, the pre-emption operation for the resource may be performed, and the BM signal may not be transmitted in the resource.

When a priority of a BM signal is lower than a priority of SL data, the first signal is the SL data, and the second signal is the BM signal, the pre-emption operation for the resource may not be performed, and the SL data may be transmitted in the resource.

A first user equipment (UE), according to exemplary embodiments of the present disclosure for achieving the above-described objective, may comprise: at least one processor, and the at least one processor may cause the first UE to perform: determining a resource by performing a resource sensing and selection (RSS) operation; comparing priorities between a first signal that the first UE intends to transmit in the resource and a second signal that the second UE intends to transmit in the resource; determining whether to perform a pre-emption operation for the resource based on a result of comparing the priorities; and performing sidelink (SL) communication based on whether to perform the pre-emption operation.

The at least one processor may further cause the first UE to perform: receiving an enable/disable indicator for the pre-emption operation from a base station, wherein when the enable/disable indicator indicates enabling of the pre-emption operation, the first UE may determine whether to perform the pre-emption operation for the resource.

The at least one processor may further cause the first UE to perform: receiving, from a base station, configuration information indicating enabling/disabling of the pre-emption operation between SL data transmissions, enabling/disabling of the pre-emption operation between beam management (BM) signal transmissions for BM operation, and enabling/disabling of the pre-emption operation between SL data transmission and BM signal transmission, wherein whether to perform the pre-emption operation for the resource may be determined based on the configuration information.

Enabling or disabling of the pre-emption operation may be configured per resource pool (RP).

A first priority of the first signal may be included in first sidelink control information (SCI) transmitted by the first UE, and a second priority of the second signal may be included in second SCI transmitted by the second UE.

When a priority of a BM signal is higher than a priority of SL data, the first signal is the BM signal, and the second signal is the SL data, the pre-emption operation for the resource may not be performed, and the BM signal may be transmitted in the resource.

When a priority of a BM signal is higher than a priority of SL data, the first signal is the SL data, and the second signal is the BM signal, the pre-emption operation for the resource may be performed, and the SL data may not be transmitted in the resource.

When a priority of a BM signal is lower than a priority of SL data, the first signal is the BM signal, and the second signal is the SL data, the pre-emption operation for the resource may be performed, and the BM signal may not be transmitted in the resource.

When a priority of a BM signal is lower than a priority of SL data, the first signal is the SL data, and the second signal is the BM signal, the pre-emption operation for the resource may not be performed, and the SL data may be transmitted in the resource.

### Advantageous Effects

According to the present disclosure, a first terminal may transmit a BM signal for BM operation. When the transmission of the BM signal of the first terminal and transmission of data of a second terminal are required in the same resource, the first terminal may perform a transmission operation for the BM signal or a pre-emption operation based on priorities. According to this method, a problem of transmission collisions in the same resource can be resolved, and sidelink (SL) communication can be efficiently performed.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a sequence chart of a first exemplary embodiment of a BM operation.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’. In the present disclosure, information may be used in the sense of information element(s), field(s), field value(s), field information, and/or parameter(s).

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

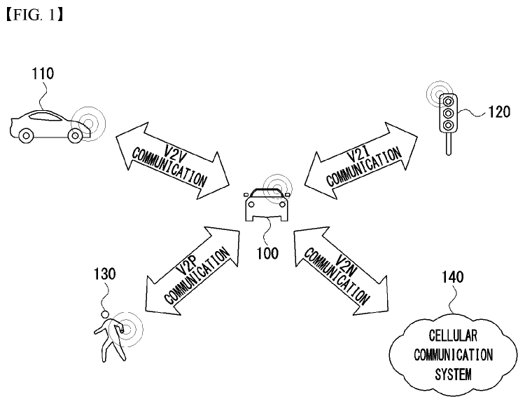

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

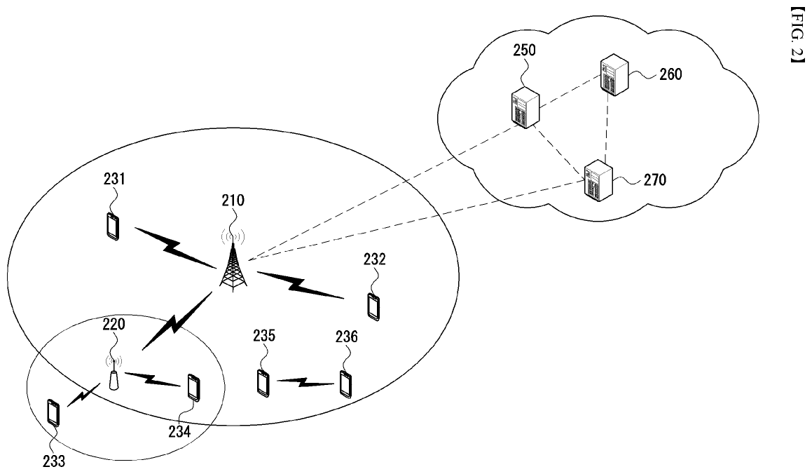

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

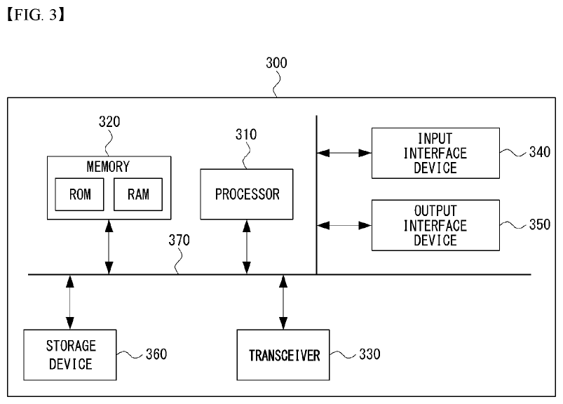

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

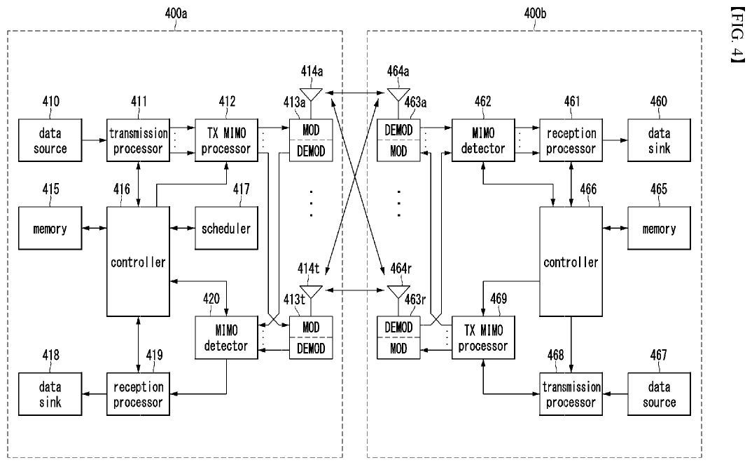

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

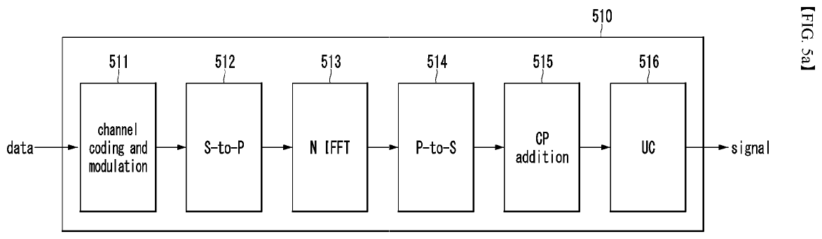

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of base | Out of coverage of |
| | station 210 | base station 210 |
| C | In coverage of base | In coverage of base |
| | station 210 | station 210 |
| D | In coverage of base | In coverage of other |
| | station 210 | base station |

Meanwhile, a user plane protocol stack of the UEs (e.g., the UEs 235 and 236) performing sidelink communications may be configured as follows.

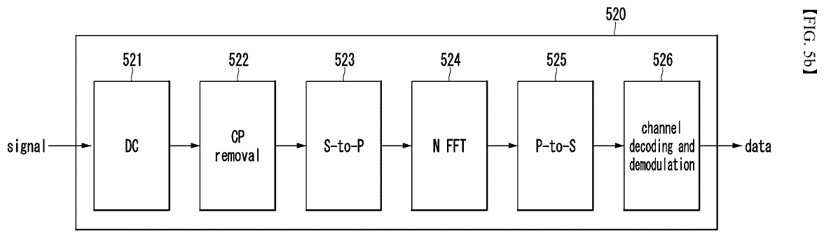

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

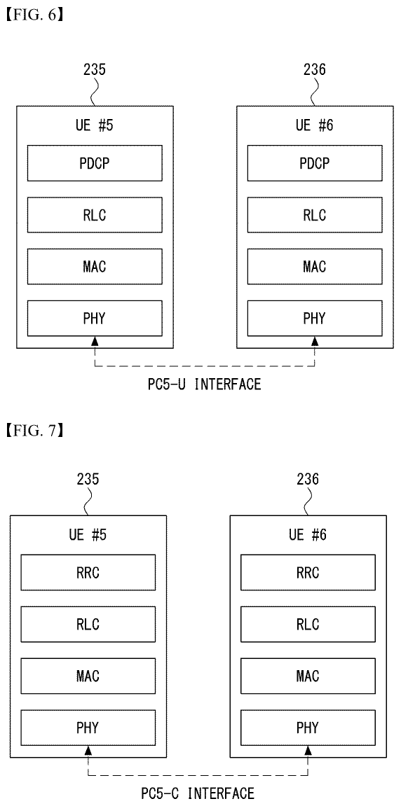

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled by base |
| | station |
| 2 | UE autonomous transmission without scheduling of |
| | base station |
| 3 | Transmission using resources scheduled by base |
| | station in V2X communications |
| 4 | UE autonomous transmission without scheduling of |
| | base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink (SL) communication may support a beam management operation. The beam management operation may be supported in FR2 bands. In the present disclosure, the beam management operation may be referred to as a BM operation. The BM operation may be performed using channel state information-reference signal (CSI-RS). In this case, a constraint on the number of symbols within a transmittable SL slot may exist. For example, PSSCH symbols for PSSCH transmission may not be sufficiently secured. The BM operation may be performed using synchronization signal block (SSB). In this case, a constraint on SSB transmission may exist. For example, considering SSB transmission, a transmission time according to a triggering time for BM operation may be changed. Accordingly, inefficiency in SL communication may increase.

Beam management operations in an NR Uu link may be defined as follows.
Signals used for CSI measurement: CSI-RS set and/or SSB
a channel quality indicator (CQI) metric for a beam: L1-reference signal received power (RSRP)
Maximum number of CSI reports per terminal: 4 (e.g., CSI reporting for 4 beams is possible)
Reported information: the largest L1-RSRP among L1-RSRPs of beams and/or differences between the largest L1-RSRP and L1-RSRPs of other beams
CSI-RS transmission type: CSI reporting type+channel used for CSI reporting
Periodic type: periodic CSI reporting+physical uplink control channel (PUCCH)
Semi-persistent type: periodic CSI reporting+PUCCH or semi-persistent CSI reporting+physical uplink shared channel (PUSCH)
Aperiodic type: aperiodic CSI reporting (e.g., aperiodic CSI reporting triggered by DCI with a CSI request field)+PUSCH
Beam adjustment may be performed for each of down transmission and reception beams. If beam reciprocity is satisfied between uplink and downlink, the BM operation (e.g., beam adjustment operation) may be performed only for downlink.

CSI-related operations in an NR SL link may be defined as follows.
Signals used for CSI measurement: CSI-RS set
CQI metric: L1-RSRP
Maximum CSI-RS ports: 2
CSI-RS transmission type: CSI reporting type+channel used for CSI reporting
Aperiodic type: aperiodic CSI reporting (e.g., aperiodic CSI reporting triggered by an SCI format 2-A or 2-C with a CSI request field)+PSSCH (e.g., MAC CE)

S-SSB related operations in NR communication may be defined as follows.
Unlike SSB transmission in an NR Uu link, S-SSB transmission in an NR SL link may be performed at a fixed periodicity. The fixed periodicity may be 160 ms.
As shown in Table 3 below, multiple S-SSBs may be transmitted in one S-SSB period depending on a frequency range (FR) and/or a subcarrier spacing (SCS).

TABLE 3

| FR | SCS | | Number of S-SSBs within an S-SSB period |
|---|---|---|---|
| FR1 | 15 | kHz | 1 |
| | 30 | kHz | 1, 2 |
| | 60 | kHz | 1, 2, 4 |
| FR2 | 60 | kHz | 1, 2, 4, 8, 16, 32 |
| | 120 | kHz | 1, 2, 4, 8, 16, 32, 64 |

In the present disclosure, the following terms may be defined to describe BM operations.

### Transmitting Terminal

A transmitting terminal may refer to a terminal that transmits data (e.g., SL data, user data) in SL communication. A transmitting terminal may be referred to as a TX terminal, transmitting UE, or TX UE. For convenience of description, a transmitting terminal may be referred to as a first terminal or a first UE. In the present disclosure, a term ‘terminal’ may be interpreted as a transmitting terminal depending on a context.

### Receiving Terminal

A receiving terminal may refer to a terminal that receives data (e.g., SL data, user data) in SL communication. A receiving terminal may be referred to as an RX terminal, receiving UE, or RX UE. For convenience of description, a receiving terminal may be referred to as a second terminal or a second UE. In the present disclosure, a term ‘terminal’ may be interpreted as a receiving terminal depending on a context.

### Beam Management-Reference Signal (BM-RS)

A BM-RS may be a reference signal used for measuring a beam quality (e.g., transmission and reception beam) between a transmitting terminal and a receiving terminal in SL communication. In other words, a BM-RS may be a reference signal used for BM operation. A beam quality measurement operation may be continuously performed. A BM-RS may be a CSI-RS (e.g., CSI-RS in existing SL communication), a modified CSI-RS, or an extended CSI-RS. Alternatively, a new reference signal for BM-RS may be defined.

### Beam State Information (BSI)

BSI may refer to beam information measured based on BM-RS. BSI may include at least one of a beam index, beam measurement information (e.g., beam quality information), or a calculation result of a beam measurement value. A beam index may be an index of a beam with the best quality or an index (or indexes) of beam(s) with beam quality equal to or greater than a threshold. Beam measurement information may include reference signal received power (RSRP), reference signal received quality (RSRP), received signal strength indicator (RSSI), and/or the like of beam(s).

In the present disclosure, a resource sensing/selection operation may be assumed to be performed based on the following basic procedures. The resource sensing/selection operation may refer to a resource sensing operation and/or a resource selection operation.
Basic procedure 1: A terminal may obtain SCI of another terminal by performing a decoding operation (e.g., blind decoding operation) on PSCCH(s) and may identify resources reserved by another terminal (e.g., scheduled resources) based on information elements included in the SCI. The terminal may continuously perform the above operation.
Basic procedure 2: When a transmitting terminal receives a resource selection trigger at a specific time, the transmitting terminal may configure a time period including the specific time and a past time relative to the specific time as a sensing window. The transmitting terminal may configure a future time period as a selection window. The transmitting terminal may identify available resource(s) (e.g., candidate resource(s)) by performing a resource sensing operation in the sensing window.
Basic procedure 3: The transmitting terminal may perform a resource sensing operation in the sensing window and may select specific resource(s) among resources not occupied by other terminals within the selection window based on resource(s) identified by the resource sensing operation (e.g., available resource(s), candidate resource(s)). The transmitting terminal may perform sidelink (SL) communication using the selected specific resource(s).

The basic procedures 1, 2, and 3 may be basic procedures of a full sensing operation. A partial sensing operation may be performed as follows. The operations proposed in the present disclosure, variations of the operations, extensions of the operations, and/or combinations of the operations with other operations may be applied to various resource sensing/selection procedures.

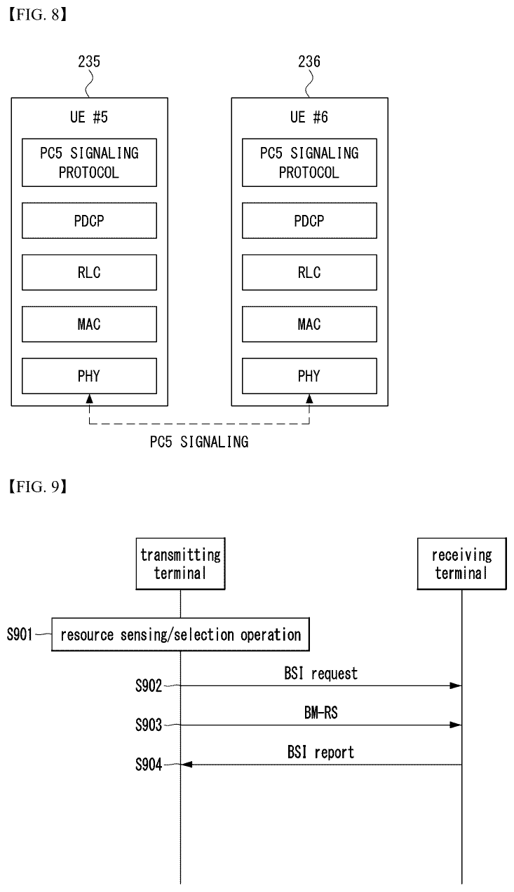

FIG. 9 is a sequence chart of a first exemplary embodiment of a BM operation.

As shown in FIG. 9, a transmitting terminal may perform a resource sensing/selection operation to sense and select transmission resources of BM signals (S901). In the present disclosure, the BM signals may include at least one of a BSI request, BM-RS, or a BSI report. For example, the transmitting terminal may determine candidate resource(s) by performing a resource sensing operation and may select one or more resources among the candidate resource(s) by performing a resource selection operation. A pre-emption operation described below may be applied in the resource sensing operation, the resource selection operation, or an additional resource selection operation after the resource selection operation. For example, the pre-emption operation may be applied to determine candidate resource(s) in the resource sensing operation. Alternatively, the pre-emption operation may be applied to select resource(s) in the resource selection operation. Alternatively, the pre-emption operation may be applied to select resource(s) in the additional resource selection operation.

The transmitting terminal may transmit a BSI request to a receiving terminal using the resource(s) selected in step S901 (S902). The receiving terminal may receive the BSI request from the transmitting terminal. When the BSI request is received, the receiving terminal may determine that transmission of a BSI report is requested. In other words, the BSI request may trigger transmission of a BSI report.

The transmitting terminal may transmit BM-RS(s) to the receiving terminal using the resource(s) selected in step S901 (S903). The receiving terminal may generate BSI by performing a measurement operation (e.g., beam measurement operation) on BM-RS(s) received from the transmitting terminal. The receiving terminal may transmit the BSI report to the transmitting terminal (S904). The transmitting terminal may receive the BSI report from the receiving terminal. The transmitting terminal may change (e.g., determine, configure) a transmission beam of the transmitting terminal based on the BSI report of the receiving terminal. The receiving terminal may change (e.g., determine, configure) a reception beam of the receiving terminal based on the BSI. Through these operations, a beam pair between the transmission beam of the transmitting terminal and the reception beam of the receiving terminal may be configured.

In step S901 and/or S902, the transmitting terminal may explicitly or implicitly indicate the execution of the receiving terminal's reception beam change (e.g., determination or configuration) operation based on BM operations. In this case, the receiving terminal may perform the reception beam change (or determination) operation after receiving BM-RS(s) without transmitting a BSI report. The transmitting terminal may not expect to receive a BSI report from the receiving terminal. Alternatively, the receiving terminal may perform the reception beam change (e.g., determination or configuration) operation after transmitting a BSI report.

The BSI request may be transmitted through standalone-type SCI or two-stage SCI. In other words, the BSI request may be included in SCI. The BSI request and the BM-RS may be transmitted in the same slot (e.g., the same SL slot). Alternatively, the BSI request and the BM-RS may be transmitted in different slots. For example, the BSI request may be transmitted in a slot #n, and the BM-RS may be transmitted in a slot #m, which is a slot after the slot #n. Each of n and m may be a natural number. m may be greater than n. When the BM-RS is transmitted after the transmission of the BSI request, the BSI request (or the SCI including the BSI request) may include resource information (e.g., time resource information and/or frequency resource information) for transmission of the BM-RS(s). The resource(s) for the transmission of the BM-RS(s) may belong to the resources selected in step S901. Additionally, the BSI request (or the SCI including the BSI request) may include resource information (e.g., time resource information and/or frequency resource information) for transmission of the BSI report. The resource(s) for the transmission of the BSI request may belong to the resources selected in step S901.

The BSI request (or the SCI including the BSI request) may include information indicating that the resource indicated by the BSI request (or the SCI) is a resource for BM-RS transmission. Terminal(s) performing blind decoding on PSCCH (e.g., SCI) may determine that the BM-RS is transmitted in a specific resource region based on indication information included in the BSI request (or SCI).

Each of the BM signals (e.g., BSI request, BM-RS, and/or BSI report) may be transmitted and received within at least one resource pool (RP), such as an RP allocated for SL communication (e.g., SL data communication) (SL-RP) or a dedicated RP for BM operation (e.g., BM-RP). If both SL-RP and BM-RP are used (e.g., operated), RP configuration information may include information indicating whether an RP configured by the RP configuration information is an SL-RP or a BM-RP. The base station may generate RP configuration information and transmit the RP configuration information to terminal(s) (e.g., transmitting terminal and/or receiving terminal) through signaling. As another method, the transmitting terminal may generate RP configuration information and transmit the RP configuration information to the receiving terminal through signaling. The transmitting terminal and/or the receiving terminal may receive the RP configuration information. The transmitting terminal may perform a transmission operation of a BSI request, a transmission operation of BM-RS(s), and/or a reception operation of a BSI report within the RP indicated by the RP configuration information. The receiving terminal may perform a reception operation of a BSI request, a reception operation of BM-RS(s), and/or a transmission operation of a BSI report within the RP indicated by the RP configuration information.

The same frequency resources (e.g., the same frequency band) may be allocated (e.g., configured) for both a BM-RP and SL-RP, and different time resources may be allocated (e.g., configured) for the BM-RP and SL-RP.

As another method, a frequency band of a BM-RP may include a part or the entirety of a frequency band of an SL-RP. A frequency band of a BM-RP may include both a frequency band of an SL-RP and a frequency band adjacent to the frequency band of the SL-RP. Time resources of a BM-RP and an SL-RP may be configured so that they do not overlap. Alternatively, a frequency band of an SL-RP may include a part or the entirety of a frequency band of a BM-RP.

Frequency resources of a BM-RP may be configured to ensure that beam information measured in the BM-RP is validly used in an SL-RP. The base station may preconfigure multiple resource regions for an SL-RP and/or multiple resource regions for a BM-RP to the terminal (e.g., transmitting terminal and/or receiving terminal) through signaling (e.g., higher-layer signaling) and may allocate a specific resource region among the multiple resource regions as a resource region for the SL-RP and/or BM-RP to the terminal. An SL-RP and a BM-RP may be paired (e.g., mapped), and a pair of the SL-RP and BM-RP may be configured to the terminal. In other words, the base station may transmit mapping information between the SL-RP and BM-RP to the terminal through signaling (e.g., higher-layer signaling). An SL-RP paired (e.g., mapped) with a BM-RP may be an SL-RP in which beam information measured in the BM-RP is validly used. The terminal may perform a BM operation in a BM-RP and may perform SL communication in an SL-RP paired with the BM-RP by using a beam (e.g., determined beam, configured beam) changed by the BM operation.

Three BM signals (e.g., BSI request, BM-RS, and BSI report) described above may be transmitted in the same RP or in different RPs. In this case, the BM signals may be transmitted according to the following cases.
Case 1: Three BM signals (e.g., BSI request, BM-RS, and BSI report) are transmitted within an SL-RP.
Case 2: Two BM signals (e.g., BSI request and BSI report) are transmitted within an SL-RP, and one BM signal (e.g., BM-RS) is transmitted within a BM-RP.
Case 3: Two BM signals (e.g., BSI request, BSI report) may be transmitted within an SL-RP, and one BM signal (e.g., BM-RS) may be selectively transmitted within either the SL-RP or a BM-RP.
Case 4: Three BM signals (e.g., BSI request, BM-RS, and BSI report) are transmitted within a BM-RP.

In Case 1, BM operations may be performed without operating an additional RP other than the SL-RP. However, a resource utilization for transmitting the BSI request, BM-RS, and BSI report within the SL-RP may increase. Consequently, traffic congestion may occur. In this case, resources for SL data transmission within the SL-RP may be insufficient, and a transmission collision between terminals may occur in a slot (e.g., SL slot).

In Case 4, since the BM operation is performed in an additional RP (e.g., BM-RP), the issues in Case 1 may be resolved. However, the receiving terminal may need to perform an additional monitoring operation (e.g., decoding operation, blind decoding operation) in the BM-RP in addition to the SL-RP to detect the BSI request. Accordingly, the load and/or energy consumption of the receiving terminal may increase.

In Case 2 or Case 3, since only the BM-RS is transmitted through the BM-RP, the issues of Case 1 (e.g., traffic congestion within the SL-RP) may be alleviated. Since the BSI request is transmitted through the SL-RP in Case 2 or Case 3, the receiving terminal only needs to perform a monitoring operation (e.g., decoding operation, blind decoding operation) in the SL-RP to detect the BSI request, thereby mitigating the issues of Case 4. When only the BM-RS is transmitted in the BM-RP, resource allocation within the SL-RP may be performed more flexibly. In other words, resource allocation within the SL-RP may be performed in a time unit smaller than a slot (e.g., a symbol unit).

In the present disclosure, for convenience of description, a BSI request may be assumed to be transmitted through SCI, the BSI request (or the SCI including the BSI request) may be assumed to include time and/or frequency resource information for BM-RS transmission, and the BSI request (or the SCI including the BSI request) may be assumed to include information indicating that resources indicated by BSI (or SCI) is a resource for BM-RS transmission. A terminal may obtain the SCI by performing PSCCH blind decoding and may determine whether a slot scheduled by the SCI (e.g., scheduled resource, reserved slot) is a resource for data transmission or a resource for BM-RS transmission based on indication information included in the SCI. The resource for data transmission or BM-RS transmission may be allocated in a slot where the SCI is transmitted. Alternatively, the resource for data transmission of data or BM-RS transmission may be allocated in a slot after the slot where the SCI is transmitted.

As another method, a BM-RNTI for BM operation may be configured. When a terminal successfully decodes the SCI using the BM-RNTI, the terminal may determine that the resource indicated by the SCI is a resource for BM operation (e.g., BM-RS transmission). When a terminal successfully decodes the SCI using an RNTI (e.g., SL-RNTI) other than the BM-RNTI, the terminal may determine that the resource indicated by the SCI is a resource for data transmission.

In the present disclosure, for convenience of description, a pre-emption operation in SL communication may be assumed to be performed as follows. The pre-emption operation may be enabled or disabled for each RP configured for each terminal. When the pre-emption operation is enabled, a first terminal performing a resource sensing/selection operation in an RP for which the pre-emption operation is enabled may obtain a second terminal's SCI (e.g., first SCI) by performing a PSCCH blind decoding operation. When a priority indicated by the SCI of the second terminal is higher than a priority of the first terminal, and a resource reserved by the SCI of the second terminal overlaps with a reserved resource of the first terminal, the first terminal may release its reserved resource. The pre-emption operation may be performed based on priorities of transmission data.

Signaling operations for data transmission, signaling operations for BM operation, and resource sensing/selection operations for BM signal transmission in each case will be described below. Operations of the terminal when the reserved resource (e.g., selected resource, candidate resource) of the terminal overlaps with the reserved resource of another terminal in each case will be described below. The reserved resource of another terminal may be identified based on information elements included in the SCI of another terminal obtained through the PSCCH blind decoding operation.

When the pre-emption operation is not performed within an RP in each case (e.g., when the pre-emption operation is disabled), resources for transmission of data and/or BM signals may be reserved through an existing resource sensing/selection operation. A terminal may select resources that are not reserved by other terminals by performing a resource sensing/selection operation and may perform transmission of data and/or BM signals using the selected resources. In the present disclosure, the resource sensing/selection operation may be referred to as a resource sensing and selection (RSS) operation. Performing the RSS operation may mean that the terminal identifies idle resources (e.g., available resources, candidate resources) by performing a resource sensing operation or that the terminal identifies idle resources (e.g., available resources, candidate resources) by performing a resource sensing operation and selects one or more resources among the idle resources by performing a resource selection operation.

[Case 1: Three BM Signals are Transmitted within an SL-RP]

When BM signals are transmitted within an SL-RP, there may be a terminal performing an RSS operation for data transmission and a terminal performing an RSS operation for BM signal transmission.

When the pre-emption operation is supported, the RSS operation may be performed considering a priority of data transmission and/or a priority of BM signal transmission.
(Scheme 1) The priority of BM signal transmission may be higher than the priority of data transmission, and the RSS operation may be performed considering the priorities.
(Scheme 2) The priority of data transmission may be higher than the priority of BM signal transmission, and the RSS operation may be performed considering the priorities.
(Scheme 3) The priority of BM signal transmission may be defined, the priority of BM signal transmission may be compared with the priority of data transmission, and the RSS operation may be performed considering a result of the priority comparison. When the priority of BM signal transmission is the same as the priority of data transmission, BM signal transmission or data transmission may be assumed to have a higher priority.

A priority of data (e.g., SL data) may be indicated by a priority field included in first-stage SCI. The field indicating the priority of data may be referred to as a data (D)-priority field. The size of the D-priority field may be 3 bits, and 8 priorities may be represented by the D-priority field. The D-priority field included in first-stage SCI may indicate one priority among the 8 priorities.

A BM-priority field indicating a priority of BM signals may be defined. The size of the BM-priority field may be defined as 3 bits. In this case, the BM-priority field may represent 8 priorities. The BM-priority field may be included in the SCI. In other words, the SCI may include the D-priority field and the BM-priority field, and the D-priority field and the BM-priority field may be distinguished within the SCI. Alternatively, the BM-priority field may not be separately configured, and a priority field (e.g., the D-priority field) may be used to indicate the priority of BM signals. In this case, SCI including the priority field may include information explicitly or implicitly indicating that the SCI is SCI for transmission of BM signals. A new first-stage SCI format (e.g., SCI format 1-B) for BM signal transmission may be defined. As another method, a priority field included in SCI decoded by an SL-RNTI may be interpreted as the D-priority field, and a priority field included in SCI decoded by the BM-RNTI may be interpreted as the BM-priority field.

The size of the priority field (e.g., the D-priority field and/or the BM-priority field) may be smaller or larger than 3 bits. The number of priority levels for data may be different from the number of priority levels for BM signals. In this case, for the comparison between the priority levels for data and the priority levels for BM signals, relative priority mapping between data and BM signals may be performed, and the priority of data and the priority of BM signals may be compared based on a result of the priority mapping. For example, a specific priority level of BM signals may be mapped to a certain priority level of data, and the priority of data and the priority of BM signals may be compared based on a result of the priority mapping. The result information of the priority mapping may be configured to terminal(s) through signaling.

In Scheme 1, the priority of BM signal transmission may be higher than the priority of data transmission. In this case, operations based on the RSS operation result may be performed according to Table 4 below. In Table 4 below, the RSS operation and/or the pre-emption operation, considering a signal (e.g., priority of the signal) that a first terminal performing the RSS operation intends to transmit and/or a signal (e.g., priority of the signal) that another terminal intends to transmit in a reserved resource (e.g., occupied resource) identified by the RSS operation, will be described. The resources selected by the RSS operation of the first terminal (or candidate resources determined by the RSS operation) may include a reserved resource (e.g., occupied resource) of another terminal. The reserved resource of another terminal and/or a type of signal (e.g., data or BM signal) to be transmitted in the reserved resource may be identified based on information elements included in SCI of another terminal.

TABLE 4

| | Signal that another | |
|---|---|---|
| Signal that the first | terminal intends to | |
| terminal performing RSS | transmit in reserved | |
| operation intends to | resource(s) identified by | Operation of the first |
| transmit | RSS operation | terminal |
| BM signal | BM signal | The first terminal determines |
| | | whether to perform a pre- |
| | | emption operation based on |
| | | priorities of BM signals |
| BM signal | Data | The first terminal does not |
| | | perform a pre-emption |
| | | operation |
| Data | BM signal | The first terminal performs a |
| | | pre-emption operation |
| Data | Data | The first terminal determines |
| | | whether to perform a pre- |
| | | emption operation based on |
| | | priorities of data |

Referring to Table 4, when the signal that the first terminal performing the RSS operation intends to transmit and the signal that another terminal intends to transmit in the reserved resource identified by the RSS operation are both BM signals, the first terminal may determine whether to perform a pre-emption operation based on priorities of the BM signals. When the priority of the BM signal of the first terminal is higher than the priority of the BM signal of another terminal, the first terminal may not release the resources selected by the RSS operation and may transmit its BM signal in the selected resources. In other words, the first terminal may not perform a pre-emption operation. On the other hand, when the priority of the BM signal of the first terminal is lower than the priority of the BM signal of another terminal, the first terminal may release the resources selected by the RSS operation and may not be able to transmit its BM signal in the released resources. In other words, the first terminal may perform a pre-emption operation. In this case, the first terminal may transmit the BM signal in another resource. The another resource may be reselected through the RSS operation.

Referring to Table 4, when the signal that the first terminal performing the RSS operation intends to transmit is a BM signal, and the signal that another terminal intends to transmit in the reserved resource identified by the RSS operation is data, the first terminal may not perform a pre-emption operation because the priority of the BM signal is higher than the priority of the data. In other words, the first terminal may not release the resources selected by the RSS operation and may transmit its BM signal in the selected resources.

Referring to Table 4, when the signal that the first terminal performing the RSS operation intends to transmit is data, and the signal that another terminal intends to transmit in the reserved resource identified by the RSS operation is a BM signal, the first terminal may perform a pre-emption operation because the priority of the BM signal is higher than the priority of the data. In other words, the first terminal may release the resources selected by the RSS operation and may not be able to transmit the data in the released resources. In this case, the first terminal may transmit the data in another resource. The another resource may be reselected through the RSS operation.

Referring to Table 4, when the signal that the first terminal performing the RSS operation intends to transmit and the signal that another terminal intends to transmit in the reserved resource identified by the RSS operation are both data, the first terminal may determine whether to perform a pre-emption operation based on priorities of the data. When the priority of the data of the first terminal is higher than the priority of the data of another terminal, the first terminal may not release the resources selected by the RSS operation and may transmit its data in the selected resources. In other words, the first terminal may not perform a pre-emption operation. On the other hand, when the priority of the data of the first terminal is lower than the priority of the data of another terminal, the first terminal may release the resources selected by the RSS operation and may not be able to transmit its data in the released resources. In other words, the first terminal may perform a pre-emption operation. In this case, the first terminal may transmit its data in another resource. The another resource may be reselected through the RSS operation.

In Scheme 2, a priority of data transmission may be higher than a priority of BM-RS transmission. In this case, operations based on the RSS operation result may be performed according to Table 5 below. In Table 5 below, the RSS operation and/or the pre-emption operation, considering a signal (e.g., priority of the signal) that the first terminal performing the RSS operation intends to transmit and/or a signal (e.g., priority of the signal) that another terminal intends to transmit in a reserved resource (e.g., occupied resource) identified by the RSS operation, will be described. The resources selected by the RSS operation of the first terminal (or candidate resources determined by the RSS operation) may include a reserved resource (e.g., occupied resource) of another terminal. The reserved resource of another terminal and/or a type of signal (e.g., data or BM signal) to be transmitted in the reserved resource may be identified based on information elements included in SCI of another terminal.

TABLE 5

| | Signal that another | |
|---|---|---|
| Signal that the first | terminal intends to | |
| terminal performing RSS | transmit in reserved | |
| operation intends to | resource(s) identified by | Operation of the first |
| transmit | RSS operation | terminal |
| BM signal | BM signal | The first terminal determines |
| | | whether to perform a pre- |
| | | emption operation based on |
| | | priorities of BM signals |
| BM signal | Data | The first terminal performs a |
| | | pre-emption operation |
| Data | BM signal | The first terminal does not |
| | | perform a pre-emption |
| | | operation |
| Data | Data | The first terminal determines |
| | | whether to perform a pre- |
| | | emption operation based on |
| | | priorities of data |

Referring to Table 5, when the signal that the first terminal performing the RSS operation intends to transmit and the signal that another terminal intends to transmit in a reserved resource identified by the RSS operation are both BM signals, the first terminal may determine whether to perform a pre-emption operation based on priorities of the BM signals. When the priority of the BM signal of the first terminal is higher than the priority of the BM signal of another terminal, the first terminal may not release the resources selected by the RSS operation and may transmit its BM signal in the selected resources. In other words, the first terminal may not perform a pre-emption operation. On the other hand, when the priority of the BM signal of the first terminal is lower than the priority of the BM signal of another terminal, the first terminal may release the resources selected by the RSS operation and may not be able to transmit its BM signal in the released resources. In other words, the first terminal may perform a pre-emption operation. In this case, the first terminal may transmit its BM signal in another resource. The another resource may be reselected through the RSS operation.

Referring to Table 5, when the signal that the first terminal performing the RSS operation intends to transmit is a BM signal, and the signal that another terminal intends to transmit in the reserved resource identified by the RSS operation is data, the first terminal may perform a pre-emption operation because the priority of the BM signal is lower than the priority of the data. In other words, the first terminal may release the resources selected by the RSS operation and may not be able to transmit the BM signal in the released resources. In this case, the first terminal may transmit the BM signal in another resource. The another resource may be reselected through the RSS operation.

Referring to Table 5, when the signal that the first terminal performing the RSS operation intends to transmit is data, and the signal that another terminal intends to transmit in the reserved resource identified by the RSS operation is a BM signal, the first terminal may not perform a pre-emption operation because the priority of the BM signal is lower than the priority of the data. In other words, the first terminal may not release the resources selected by the RSS operation and may transmit the data in the selected resources.

Referring to Table 5, when the signal that the first terminal performing the RSS operation intends to transmit and the signal that another terminal intends to transmit in the reserved resource identified by the RSS operation are both data, the first terminal may determine whether to perform a pre-emption operation based on priorities of the data. When the priority of the data of the first terminal is higher than the priority of the data of another terminal, the first terminal may not release the resources selected by the RSS operation and may transmit its data in the selected resources. In other words, the first terminal may not perform a pre-emption operation. On the other hand, when the priority of the data of the first terminal is lower than the priority of the data of another terminal, the first terminal may release the resources selected by the RSS operation and may not be able to transmit its data in the released resources. In other words, the first terminal may perform a pre-emption operation. In this case, the first terminal may transmit its data in another resource. The another resource may be reselected through the RSS operation.

In Scheme 3, a priority of BM signal transmission may be defined, and the priority of BM signal transmission may be compared with a priority of data transmission, and the RSS operation may be performed considering a result of the priority comparison. When the priority of BM signal transmission is the same as the priority of data transmission, one of BM signal transmission or data transmission may be assumed to have a higher priority. The number of priority levels for BM signals and the number of priority levels for data may be defined to be the same. A lower value of the priority level may be defined as having a higher priority, and a higher value of the priority level may be defined as having a lower priority.

When a priority level of a BM signal and a priority level of data are the same, either the BM signal or the data may be determined to have a higher priority, and transmission of the BM signal or data determined to have a higher priority may be performed. In Table 6 below, when a priority level of the BM signal and a priority level of the data are the same, the BM signal may be assumed to have a higher priority than the data. The resources selected by the RSS operation of the first terminal (or candidate resources determined by the RSS operation) may include a reserved resource (e.g., occupied resource) of another terminal. The reserved resource of another terminal and/or a type of signal (e.g., data or BM signal) to be transmitted in the reserved resource may be identified based on information elements included in SCI of another terminal.

TABLE 6

| | Signal that another | |
|---|---|---|
| Signal that the first | terminal intends to | |
| terminal performing RSS | transmit in reserved | |
| operation intends to | resource(s) identified by | Operation of the first |
| transmit | RSS operation | terminal |
| BM signal | BM signal | The first terminal determines |
| | | whether to perform a pre- |
| | | emption operation based on |
| | | priorities of BM signals |
| BM signal | Data | The first terminal determines |
| | | whether to perform a pre- |
| | | emption operation based on |
| | | priority comparison between |
| | | BM signal and data. When |
| | | priority levels of the BM |
| | | signal and data are the same, |
| | | the first terminal does not |
| | | perform a pre-emption |
| | | operation |
| Data | BM signal | The first terminal determines |
| | | whether to perform a pre- |
| | | emption operation based on |
| | | priority comparison between |
| | | BM signal and data. When |
| | | priority levels of the BM |
| | | signal and data are the same, |
| | | the first terminal performs a |
| | | pre-emption operation |
| Data | Data | The first terminal determines |
| | | whether to perform a pre- |
| | | emption operation based on |
| | | priorities of data |

Referring to Table 6, when the signal that the first terminal performing the RSS operation intends to transmit and the signal that another terminal intends to transmit in the reserved resource identified by the RSS operation are both BM signals, the first terminal may determine whether to perform a pre-emption operation based on priorities of the BM signals. When the priority of the BM signal of the first terminal is higher than the priority of the BM signal of another terminal, the first terminal may not release the resources selected by the RSS operation and may transmit its BM signal in the selected resources. In other words, the first terminal may not perform a pre-emption operation. On the other hand, when the priority of the BM signal of the first terminal is lower than the priority of the BM signal of another terminal, the first terminal may release the resources selected by the RSS operation and may not be able to transmit its BM signal in the released resources. In other words, the first terminal may perform a pre-emption operation. In this case, the first terminal may transmit its BM signal in another resource. The another resource may be reselected through the RSS operation.

Referring to Table 6, when the signal that the first terminal performing the RSS operation intends to transmit is a BM signal, the signal that another terminal intends to transmit in the reserved resource identified by the RSS operation is data, and Scheme 3 is applied, the first terminal may determine whether to perform a pre-emption operation based on a result of comparison between priorities of the BM signal and the data. When the priority of the BM signal of the first terminal is higher than the priority of the data of another terminal, the first terminal may not release the resources selected by the RSS operation and may transmit the BM signal in the selected resources. In other words, the first terminal may not perform a pre-emption operation. On the other hand, when the priority of the BM signal of the first terminal is lower than the priority of the data of another terminal, the first terminal may release the resources selected by the RSS operation and may not be able to transmit the BM signal in the released resources. In other words, the first terminal may perform a pre-emption operation. In this case, the first terminal may transmit the BM signal in another resource. The another resource may be reselected through the RSS operation. When the priority of the BM signal of the first terminal is the same as the priority of the data of another terminal, since BM signal transmission takes precedence over data transmission, the first terminal may not release the resources selected by the RSS operation and may transmit the BM signal in the selected resources. In other words, the first terminal may not perform a pre-emption operation.

Referring to Table 6, when the signal that the first terminal performing the RSS operation intends to transmit is data, the signal that another terminal intends to transmit in the reserved resource identified by the RSS operation is a BM signal, and scheme 3 is applied, the first terminal may determine whether to perform a pre-emption operation based on a result of comparison between priorities of the data and the BM signal. When the priority of the data of the first terminal is higher than the priority of the BM signal of another terminal, the first terminal may not release the resources selected by the RSS operation and may transmit the data in the selected resources. In other words, the first terminal may not perform a pre-emption operation. On the other hand, when the priority of the data of the first terminal is lower than the priority of the BM signal of another terminal, the first terminal may release the resources selected by the RSS operation and may not be able to transmit the data in the released resources. In other words, the first terminal may perform a pre-emption operation. In this case, the first terminal may transmit the data in another resource. The another resource may be reselected through the RSS operation. When the priority of the data of the first terminal is the same as the priority of the BM signal of the other terminal, since BM signal transmission takes precedence over data transmission, the first terminal may release the resources selected by the RSS operation and may not be able to transmit the data in the released resources. In other words, the first terminal may perform a pre-emption operation. In this case, the first terminal may transmit the data in another resource. The another resource may be reselected through the RSS operation.

Referring to Table 6, when the signal that the first terminal performing the RSS operation intends to transmit and the signal that another terminal intends to transmit in the reserved resource identified by the RSS operation are both data, the first terminal may determine whether to perform a pre-emption operation based on priorities of the data. When the priority of the data of the first terminal is higher than the priority of the data of the other terminal, the first terminal may not release the resources selected by the RSS operation and may transmit its data in the selected resources. In other words, the first terminal may not perform a pre-emption operation. On the other hand, when the priority of the data of the first terminal is lower than the priority of the data of the other terminal, the first terminal may release the resources selected by the RSS operation and may not be able to transmit its data in the released resources. In other words, the first terminal may perform a pre-emption operation. In this case, the first terminal may transmit its data in another resource. The another resource may be reselected through the RSS operation.

A variation of Scheme 1, an extension of Scheme 1, a variation of Scheme 2, an extension of Scheme 2, a variation of Scheme 3, and/or an extension of Scheme 3 A combination of Scheme 1, Scheme 2, and/or Scheme 3 may be applied.

A combination of Scheme 1 and Scheme 2 (hereinafter referred to as ‘combination 1-2’) may be applied. When the combination 1-2 is applied, the priority of the BM signal may be indicated by a 1-bit indicator. When the 1-bit indicator is set to a first value (e.g., 0), the priority of the BM signal may be higher than the priority of the data. When the 1-bit indicator is set to a second value (e.g., 1), the priority of the BM signal may be lower than the priority of the data. Whether to perform a pre-emption operation may be determined based on the 1-bit indicator of the BM signal.

When transmission of BM signals (e.g., a first BM signal and a second BM signal) is required in the same resources, whether to perform a pre-emption operation may be determined by considering a priority of the first BM signal and a priority of the second BM signal. When different terminals intend to transmit BM signals in the same resources (e.g., the same reserved resources), the different terminals may each determine whether to perform a pre-emption operation based on the 1-bit indicator of each BM signal.

For example, when a signal that the first terminal performing the RSS operation intends to transmit and a signal that another terminal intends to transmit in the reserved resource identified by the RSS operation are both BM signals, the first terminal may compare the 1-bit indicator of the BM signal of the first terminal and the 1-bit indicator of the BM signal of another terminal. When the 1-bit indicator of the BM signal of the first terminal is set to the first value, and the 1-bit indicator of the BM signal of the other terminal is set to the second value, the first terminal may determine that transmission of the BM signal of the first terminal takes precedence over transmission of the BM signal of another terminal. The first terminal may not release the resources selected by the RSS operation and may transmit its BM signal in the selected resources. In other words, the first terminal may not perform a pre-emption operation. On the other hand, when the 1-bit indicator of the BM signal of the first terminal is set to the second value, and the 1-bit indicator of the BM signal of another terminal is set to the first value, the first terminal may determine that transmission of the BM signal of another terminal takes precedence over transmission of the BM signal of the first terminal. The first terminal may release the resources selected by the RSS operation and may not be able to transmit its BM signal in the released resources. In other words, the first terminal may perform a pre-emption operation. In this case, the first terminal may transmit its BM signal in another resource. The another resource may be reselected through the RSS operation.

A specific scheme among the aforementioned schemes may be used. The base station may configure a scheme used for each RP to the terminal(s) through signaling. For example, an enable/disable indicator for each of Scheme 1, Scheme 2, and Scheme 3 may be configured per RP. Whether to perform a pre-emption operation may be determined by considering the enable/disable indicator. The base station may transmit an enable indicator or a disable indicator for a pre-emption operation (e.g., RP-specific pre-emption operation) to the terminal(s) through signaling. Enabling or disabling of a pre-emption operation between data transmissions in the same resources, enabling or disabling of a pre-emption operation between BM signal transmissions in the same resources, and enabling or disabling of a pre-emption operation between data transmission and BM signal transmission in the same resources may be configured per RP. The enabling or disabling of a pre-emption operation for each RP may be defined as shown in Table 7 below. The base station may preconfigure configuration schemes defined in Table 7 to the terminal(s) through signaling (e.g., RRC signaling) and may transmit information indicating one of the configuration schemes to the terminal(s) through signaling (e.g., MAC signaling and/or PHY signaling).

TABLE 7

| | | | Pre-emption |
|---|---|---|---|
| | | | between data |
| | Pre-emption | Pre-emption | transmission and |
| Configuration | between data | between BM signal | BM signal |
| scheme | transmissions | transmissions | transmission |
| #1 | Enabled | Enabled | Enabled |
| #2 | Enabled | Enabled | Disabled |
| #3 | Enabled | Disabled | Enabled |
| #4 | Enabled | Disabled | Disabled |
| #5 | Disabled | Enabled | Enabled |
| #6 | Disabled | Enabled | Disabled |
| #7 | Disabled | Disabled | Enabled |
| #8 | Disabled | Disabled | Disabled |

Referring to Table 7, enabling or disabling of a pre-emption operation between data transmissions in the same resources, enabling or disabling of a pre-emption operation between BM signal transmissions in the same resources, and enabling or disabling of a pre-emption operation between data transmission and BM signal transmission in the same resources may be configured for a single RP. Based on the enabling or disabling of a pre-emption operation between data transmissions in the same resources, enabling or disabling of a pre-emption operation between BM signal transmissions in the same resources, and enabling or disabling of a pre-emption operation between data transmission and BM signal transmission, 8 configuration schemes (e.g., configuration scheme #1 to configuration scheme #8) may be defined.

In the configuration scheme #1, a pre-emption operation between data transmissions in the same resources may be enabled, a pre-emption operation between BM signal transmissions in the same resources may be enabled, and a pre-emption operation between data transmission and BM signal transmission in the same resources may be enabled. In the configuration scheme #8, a pre-emption operation between data transmissions in the same resources may be disabled, a pre-emption operation between BM signal transmissions in the same resources may be disabled, and a pre-emption operation between data transmission and BM signal transmission in the same resources may be disabled. In other words, in the configuration scheme #8, a pre-emption operation may not be performed.

In the configuration scheme #7, when a signal that the first terminal performing the RSS operation intends to transmit is a BM signal, and a signal that another terminal intends to transmit in a reserved resource identified by the RSS operation is data, or when the signal that the first terminal performing the RSS operation intends to transmit is data, and the signal that another terminal intends to transmit in the reserved resource identified by the RSS operation is a BM signal, a pre-emption operation may be enabled. In this case, the first terminal may determine whether to perform a pre-emption operation based on a result of priority comparison between the BM signal and the data.

In the configuration scheme #7, when a signal that the first terminal performing the RSS operation intends to transmit and a signal that another terminal intends to transmit in a reserved resource identified by the RSS operation are both BM signals or both data, a pre-emption operation may be disabled. In this case, the first terminal may not perform a pre-emption operation regardless of priorities of the BM signal and the data.

In other configuration schemes in Table 7, the first terminal may determine whether to perform a pre-emption operation based on enabling or disabling of a pre-emption operation. The exemplary embodiments in Table 4, Table 5, and/or Table 6 may be applied to the exemplary embodiment in Table 7. Additionally, variations, extensions, and/or combinations of the exemplary embodiments in Table 4, Table 5, and/or Table 6 may be applied to the exemplary embodiment in Table 7.

[Case 2: Two BM Signals (e.g., BSI Request, BSI Report) are Transmitted Within an SL-RP, and One BM Signal (e.g., BM-RS) is Transmitted within a BM-RP]

A specific pre-emption operation may be supported, and an RSS operation within the SL-RP and/or BM-RP may be performed based on a priority of the BM signal. The BSI request and/or BSI report may be transmitted in the SL-RP, and the BM-RS may be transmitted in the BM-RP. The pre-emption operation within the SL-RP and/or BM-RP may be a default operation. Alternatively, the pre-emption operation within the SL-RP and/or BM-RP may be enabled or disabled. As in Case 1, where the exemplary embodiment of Table 7 is applied, enabling or disabling of a pre-emption operation between data transmissions in the same resources, enabling or disabling of a pre-emption operation between BM signal transmissions in the same resources, and enabling or disabling of a pre-emption operation between data transmission and BM signal transmission in the same resources may be configured for the SL-RP. Enabling or disabling of a pre-emption operation between BM signal transmissions in the same resources may be configured for the BM-RP.

When a pre-emption operation is configured to be performed within the SL-RP and/or BM-RP, the exemplary embodiment of Table 4, variations, extensions, and/or combinations for the exemplary embodiment of Table 4, the exemplary embodiment of Table 5, variations, extensions, and/or combinations for the exemplary embodiment of Table 5, the exemplary embodiment of Table 6, variations, extensions, and/or combinations for the exemplary embodiment of Table 6, the exemplary embodiment of Table 7, and/or variations, extensions, and/or combinations for the exemplary embodiment of Table 7 in Case 1 may be applied to Case 2.

Since only the BM-RS is transmitted within the BM-RP, a pre-emption operation within the BM-RP may be performed when a signal that the first terminal performing the RSS operation intends to transmit and a signal that another terminal intends to transmit in a reserved resource identified by the RSS operation are both BM signals. For example, the first terminal may determine whether to perform a pre-emption operation based on a result of comparison between priorities of the BM signal (e.g., BM-RS) of the first terminal and the BM signal (e.g., BM-RS) of another terminal. The priority of the BM signal may be indicated by an information element included in the BSI request (or SCI). The pre-emption method between BM signals in Case 1, variations of the pre-emption method, extensions of the pre-emption method, and/or combinations of the pre-emption method with other methods may be applied to the pre-emption method for the BM-RP in Case 2.

### [Case 3: Two BM Signals (e.g., BSI Request, BSI Report) are Transmitted Within an SL-RP, and One BM Signal (e.g., BM-RS) is Selectively Transmitted Within Either the SL-RP or a BM-RP]

A specific pre-emption operation may be supported, and an RSS operation within the SL-RP and/or BM-RP may be performed based on a priority of the BM signal. The BSI request and/or BSI report may be transmitted within the SL-RP, and the BM-RS may be selectively transmitted within either the SL-RP or the BM-RP. The pre-emption operation within the SL-RP and/or BM-RP may be a default operation. Alternatively, the pre-emption operation within the SL-RP and/or BM-RP may be enabled or disabled.

The pre-emption method in Case 1 and/or Case 2 may be applied to Case 3. When the BM-RS is transmitted within the SL-RP in Case 3, the exemplary embodiment of Case 1, variations of the exemplary embodiment of Case 1, extensions of the exemplary embodiment of Case 1, and/or combinations of the exemplary embodiment of Case 1 with other exemplary embodiments may be applied. When the BM-RS is transmitted within the BM-RP in Case 3, the exemplary embodiment of Case 2, variations of the exemplary embodiment of Case 2, extensions of the exemplary embodiment of Case 2, and/or combinations of the exemplary embodiment of Case 2 with other exemplary embodiments may be applied. In this case, the BSI request (e.g., SCI including the BSI request) may include information indicating the RP (e.g., BM-RP or SL-RP) in which the BM-RS is transmitted.

[Case 4: Three BM Signals (e.g., BSI Request, BM-RS, BSI Report) are Transmitted within a BM-RP]

A specific pre-emption operation may be supported, and an RSS operation within the BM-RP may be performed based on a priority of the BM signal. The pre-emption operation within the BM-RP may be a default operation. Alternatively, the pre-emption operation within the BM-RP may be enabled or disabled. All BM signals may be transmitted within the BM-RP, and when the pre-emption operation within the BM-RP is enabled, the following operations may be performed.

The pre-emption operation within the BM-RP may be performed when a signal that the first terminal performing the RSS operation intends to transmit and a signal that another terminal intends to transmit in a reserved resource identified by the RSS operation are both BM signals. For example, the first terminal may determine whether to perform a pre-emption operation based on a result of comparison between priorities of the BM signal of the first terminal and the BM signal of another terminal. The pre-emption method between BM signals in Case 1, variations of the pre-emption method, extensions of the pre-emption method, and/or combinations of the pre-emption method with other methods may be applied to the pre-emption method in Case 4.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
determining a resource by performing a resource sensing and selection (RSS) operation;
comparing priorities between a first signal that the first UE intends to transmit in the resource and a second signal that the second UE intends to transmit in the resource;
determining whether to perform a pre-emption operation for the resource based on a result of comparing the priorities; and
performing sidelink (SL) communication based on whether to perform the pre-emption operation.

2. The method according to claim 1, further comprising: receiving an enable/disable indicator for the pre-emption operation from a base station,
wherein when the enable/disable indicator indicates enabling of the pre-emption operation, the first UE determines whether to perform the pre-emption operation for the resource.

3. The method according to claim 1, further comprising: receiving, from a base station, configuration information indicating enabling/disabling of the pre-emption operation between SL data transmissions, enabling/disabling of the pre-emption operation between beam management (BM) signal transmissions for BM operation, and enabling/disabling of the pre-emption operation between SL data transmission and BM signal transmission,
wherein whether to perform the pre-emption operation for the resource is determined based on the configuration information.

4. The method according to claim 1, wherein enabling or disabling of the pre-emption operation is configured per resource pool (RP).

5. The method according to claim 1, wherein a first priority of the first signal is included in first sidelink control information (SCI) transmitted by the first UE, and a second priority of the second signal is included in second SCI transmitted by the second UE.

6. The method according to claim 1, wherein each of the first signal and the second signal is a BM signal or SL data, and SCI for transmission of the BM signal is distinct from SCI for transmission of the SL data.

7. The method according to claim 6, wherein the SL data is transmitted in an SL-RP, the BM signal is transmitted in a BM-RP configured for BM operation or the SL-RP, and the BM-RP is configured to be distinguished from the SL-RP.

8. The method according to claim 1, wherein when a priority of a BM signal is higher than a priority of SL data, the first signal is the BM signal, and the second signal is the SL data, the pre-emption operation for the resource is not performed, and the BM signal is transmitted in the resource.

9. The method according to claim 1, wherein when a priority of a BM signal is higher than a priority of SL data, the first signal is the SL data, and the second signal is the BM signal, the pre-emption operation for the resource is performed, and the SL data is not transmitted in the resource.

10. The method according to claim 1, wherein when a priority of a BM signal is lower than a priority of SL data, the first signal is the BM signal, and the second signal is the SL data, the pre-emption operation for the resource is performed, and the BM signal is not transmitted in the resource.

11. The method according to claim 1, wherein when a priority of a BM signal is lower than a priority of SL data, the first signal is the SL data, and the second signal is the BM signal, the pre-emption operation for the resource is not performed, and the SL data is transmitted in the resource.

12. A first user equipment (UE) comprising at least one processor, wherein the at least one processor causes the first UE to perform:
determining a resource by performing a resource sensing and selection (RSS) operation;
comparing priorities between a first signal that the first UE intends to transmit in the resource and a second signal that the second UE intends to transmit in the resource;
determining whether to perform a pre-emption operation for the resource based on a result of comparing the priorities; and
performing sidelink (SL) communication based on whether to perform the pre-emption operation.

13. The first UE according to claim 12, wherein the at least one processor further causes the first UE to perform: receiving an enable/disable indicator for the pre-emption operation from a base station, wherein when the enable/disable indicator indicates enabling of the pre-emption operation, the first UE determines whether to perform the pre-emption operation for the resource.

14. The first UE according to claim 12, wherein the at least one processor further causes the first UE to perform: receiving, from a base station, configuration information indicating enabling/disabling of the pre-emption operation between SL data transmissions, enabling/disabling of the pre-emption operation between beam management (BM) signal transmissions for BM operation, and enabling/disabling of the pre-emption operation between SL data transmission and BM signal transmission, wherein whether to perform the pre-emption operation for the resource is determined based on the configuration information.

15. The first UE according to claim 12, wherein enabling or disabling of the pre-emption operation is configured per resource pool (RP).

16. The first UE according to claim 12, wherein a first priority of the first signal is included in first sidelink control information (SCI) transmitted by the first UE, and a second priority of the second signal is included in second SCI transmitted by the second UE.

17. The first UE according to claim 12, wherein when a priority of a BM signal is higher than a priority of SL data, the first signal is the BM signal, and the second signal is the SL data, the pre-emption operation for the resource is not performed, and the BM signal is transmitted in the resource.

18. The first UE according to claim 12, wherein when a priority of a BM signal is higher than a priority of SL data, the first signal is the SL data, and the second signal is the BM signal, the pre-emption operation for the resource is performed, and the SL data is not transmitted in the resource.

19. The first UE according to claim 12, wherein when a priority of a BM signal is lower than a priority of SL data, the first signal is the BM signal, and the second signal is the SL data, the pre-emption operation for the resource is performed, and the BM signal is not transmitted in the resource.

20. The first UE according to claim 12, wherein when a priority of a BM signal is lower than a priority of SL data, the first signal is the SL data, and the second signal is the BM signal, the pre-emption operation for the resource is not performed, and the SL data is transmitted in the resource.
